(19) United States
(12) Patent Application Publication
(10) Pub. No.: US 2010/0315004 A1
(43) Pub. Date: Dec. 16, 2010

(54) Lamp

(76) Inventors: Alex Horng, Kaohsiung (TW); Chi-Hung Kuo, Kaohsiung (TW); Chia-Chin Wu, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/482,515

(22) Filed: Jun. 11, 2009

(51) Int. Cl. H01J 61/52

(52) U.S. Cl. 315/117

(57) ABSTRACT

A lamp includes a lighting module having a lighting element and a control circuit electrically connected to the lighting element. The lamp further includes a control unit having a temperature sensor and a processor electrically connected to the temperature sensor and the control circuit. The temperature sensor senses a temperature of the lighting element and generates a temperature sensing result. The processor controls brightness of the lighting element based on the temperature sensing result of the temperature sensor. Since the brightness of the lighting element can be controlled by the processor through the control circuit using the temperature sensing result, overheating of the lighting element during operation can be avoided. The service life of the lighting element is, thus, prolonged.

### BACKGROUND OF THE INVENTION

1. Field of the Invention

The present invention relates to a lamp and, more particularly, to a lamp capable of avoiding overheating.

2. Description of the Related Art

Conventional lamps include a lighting module having a lighting element such as a light-emitted diode or a light bulb to emit light beams for illumination. However, the lamps are liable to malfunction and have shortened lifetimes due to overheating of the lighting element. Fins or heat-dissipating fans have been proposed to avoid high heat during operation of the lighting module.

FIG. 1 shows a conventional lamp 9 including a light-transmittable hollow housing 91. A lighting module 92 is received in the housing 91 for illuminating purposes. A fin 93 is coupled to the lighting module 92 for absorbing heat generated by the lighting module 92 when supplied with electricity. A heat-dissipating fan 94 is coupled to the fin 93 and capable of driving air currents to pass through the fin 93, providing rapid heat exchange between the fin 93 and the air currents and lowering the temperature of the lighting module 92. Thus, the service life of the lighting module 92 can be prolonged. More heat is generated when the lighting module 92 is brighter. However, the lamp 9 could not detect the temperature of the lighting module 92 and, thus, could not adjust the brightness of the lighting module 92 according to the temperature detection, leading to the risk of overheating of the lighting module 92. Furthermore, the heat-dissipating fan 94 can not be activated to increase the heat-dissipating effect in response to overheating of the lighting module 92.

### SUMMARY OF THE INVENTION

The primary objective of the present invention is to provide a lamp capable of sensing and controlling the temperature of a lighting module.

Another objective of the present invention is to provide a lamp capable of sensing the temperature of the lighting module to control operation modes of a heat-dissipating fan, providing a better heat-dissipating effect.

In a first aspect, a lamp according to the preferred teachings of the present invention includes a lighting module and a control unit. The lighting module includes a lighting element and a control circuit electrically connected to the lighting element. The control unit includes a temperature sensor and a processor electrically connected to the temperature sensor and the control circuit. The temperature sensor senses a temperature of the lighting element and generates a temperature sensing result. The processor controls brightness of the lighting element based on the temperature sensing result of the temperature sensor. Since the brightness of the lighting element can be controlled by the processor through the control circuit using the temperature sensing result, overheating of the lighting element during operation can be avoided. The service life of the lighting element is, thus, prolonged.

In a second aspect, a lamp according to the preferred teachings of the present invention includes a lighting module, a control unit, and a heat-dissipating module. The lighting module includes a lighting element and a control circuit electrically connected to the lighting element. The control unit includes a temperature sensor and a processor electrically connected to the temperature sensor and the control circuit of the lighting module. The heat-dissipating module includes a heat-dissipating fan and a drive circuit electrically connected to the heat-dissipating fan and the processor of the control unit. The temperature sensor senses a temperature of the lighting element and generates a temperature sensing result. The processor controls an operation mode of the heat-dissipating fan through the drive circuit based on the temperature sensing result of the temperature sensor. Since the operation mode of the heat-dissipating fan can be controlled by the processor through the drive circuit using the temperature sensing result, the heat-dissipating fan can operate in a more efficient manner.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a conventional lamp with a heat-dissipating fan with a portion of the lamp cross sectioned.

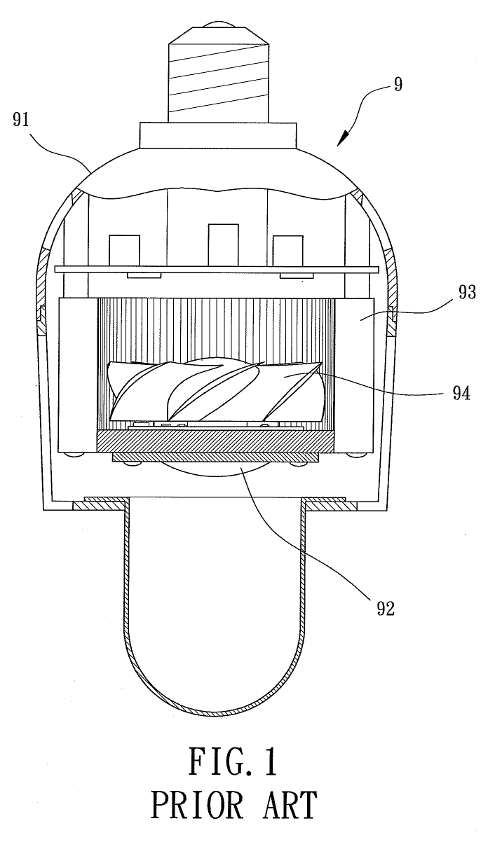

FIG. 2 shows a block diagram illustrating structure of a lamp of a first embodiment according to the preferred teachings of the present invention.

FIG. 3 shows a block diagram illustrating structure of a lamp of a second embodiment according to the preferred teachings of the present invention.

FIG. 4 shows a schematic, exploded and perspective view of a heat-dissipating module and a lighting element of the second embodiment according to the preferred teachings of the present invention.

FIG. 5 shows a block diagram illustrating structure of a lamp of a third embodiment according to the preferred teachings of the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

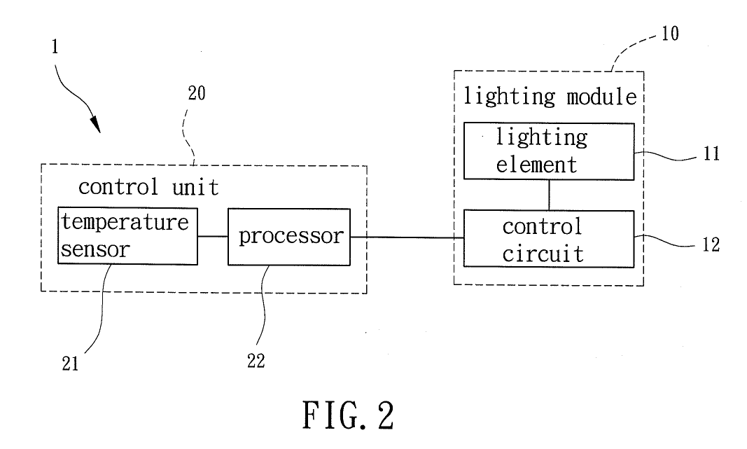

A lamp of a first embodiment according to the preferred teachings of the present invention is shown in FIG. 2 and generally designated 1. In this embodiment, the lamp 1 includes a lighting module 10 and a control unit 20. The lighting module 10 and the control unit 20 are preferably mounted and, thus, protected in a housing. The housing can be mounted to a lamp seat on a wall, ceiling, or desk. The lighting module 10 can be powered by regular electricity service system to provide illumination. The control unit 20 can control brightness of the lighting module 10 to adjust the temperature of the lighting module 10.

The lighting module 10 includes a lighting element 11 and a control circuit 12. The lighting element 11 can be a light-emitted diode (LED), a light bulb, or any element capable of providing illuminating function. The control circuit 12 is electrically connected to the lighting element 11 for controlling emission of light beams of the lighting element 11.

The control unit 20 includes a temperature sensor 21 and a processor 22 electrically connected to the temperature sensor 21 and the control circuit 12. The temperature sensor 21 is located adjacent the lighting element 11 to sense the temperature of the lighting element 11 and to generate a temperature sensing result. The processor 22 receives the temperature sensing result and generates a control signal after operation. The control signal is output to the control circuit 12 so that the brightness of the lighting element 11 can be controlled by the processor 22 via the control circuit 12.

As an example of use, during operation of the lamp 1 of the first embodiment, the temperature sensor 21 generates a temperature sensing result when overheating of the lighting element 11 is sensed. The processor 22 receives the temperature sensing result and generates a control signal after operation. The control signal is output to the control circuit 12 so that the brightness of the lighting element 11 can be reduced under control of the processor 22 via the control circuit 12. The temperature of the lighting element 11 is, thus, reduced. On the other hand, when the temperature of the lighting element 11 sensed by the temperature sensor 21 is lower than a predetermined value, the brightness of the lighting element 11 can be increased through control of the processor 22 via the control circuit 12. Thus, the temperature of the lighting element 11 can be reliably controlled.

Thus, the lamp 1 of the first embodiment according to the preferred teachings of the present invention can sense the practical temperature of the lighting element 11 during operation. The brightness of the lighting element 11 can be adjusted based on the temperature of the lighting element 11 sensed, avoiding overheating and damage to the lighting element 11. The service life of the lighting element 11 is prolonged accordingly.

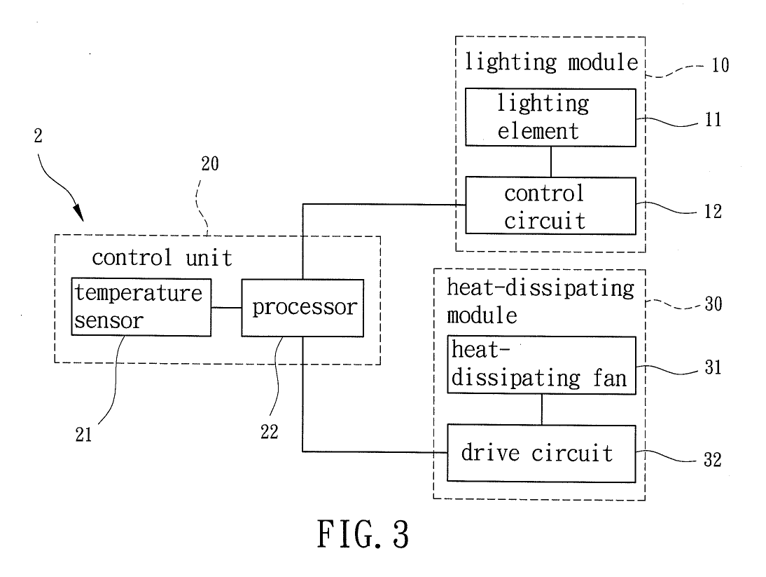

FIG. 3 shows a lamp 2 of a second embodiment according to the preferred teachings of the present invention. In this embodiment, the lamp 2 includes a lighting module 10, a control unit 20, and a heat-dissipating module 30. The lighting module 10 and the control unit 20 are the same as those in the first embodiment and, therefore, not described in detail to avoid redundancy.

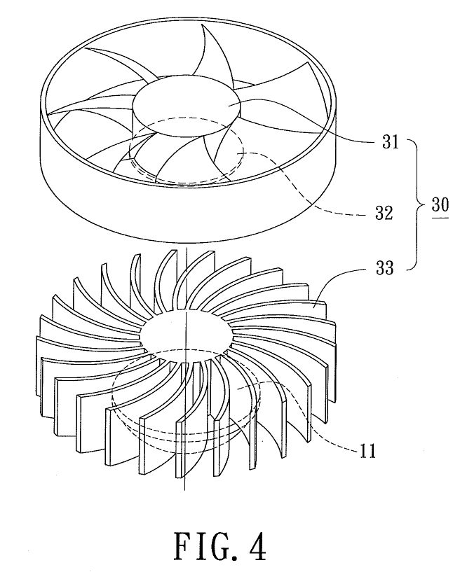

The heat-dissipating module 30 of the second embodiment includes a heat-dissipating fan 31 and a drive circuit 32. The heat-dissipating fan 31 can be an axial fan, a blower fan, or any mechanism capable of providing a heat-dissipating effect. The heat-dissipating fan 31 can be directly coupled to the lighting element 11 of the lighting module 10. Alternatively, the heat-dissipating fan 31 can be located at a side of the lighting element 11. The drive circuit 32 is electrically connected to the heat-dissipating fan 31 and the processor 22 for driving the heat-dissipating fan 31 to rotate, so that an amount of wind can be generated for heat-dissipating purposes. Particularly, as shown in FIG. 4, the heat-dissipating module 30 can further include a sink 33 directly coupled to the lighting element 11 of the lighting module 10, and the heat-dissipating fan 31 can also be coupled to the sink 33. Thus, the heat generated by the lighting element 11 can be transmitted to the sink 33. The heat-dissipating fan 31 can be activated to drive air currents to pass through the sink 33, so that rapid heat exchange can be conducted between the sink 33 and the air currents, enhancing the overall heat-dissipating effect.

As an example of use, during operation of the lamp 2 of the second embodiment, the heat-dissipating module 30 can be utilized to control the temperature of the lighting element 11 in addition to controlling of the brightness of the lighting element 11 by the control unit 20. Specifically, the temperature sensor 21 generates a temperature sensing result after sensing the temperature of the lighting element 11. The processor 22 receives the temperature sensing result and generates a control signal after operation. The control signal is output to the drive circuit 32 so that the operation mode of the heat-dissipating fan 31 can be changed. In a case that the temperature of the lighting element 11 is too high, the rotating speed of the heat-dissipating fan 31 is increased under control of the processor 22 of the control unit 20 to generate more amount of wind. On the other hand, when the temperature of the lighting element 11 is too low, the rotating speed of the heat-dissipating fan 31 is reduced under control of the processor 22 of the control unit 20 to save electricity.

Thus, in addition to avoiding overheating of the lighting element 11 by adjusting the brightness of the lighting element 11 through the control unit 20, the lamp 2 of the second embodiment according to the preferred teachings of the present invention can sense the practical temperature of the lighting element 11 during operation via the temperature sensor 21. The operation mode of the heat-dissipating fan 31 can be adjusted based on the temperature of the lighting element 11 sensed, providing enhanced heat-dissipating effect.

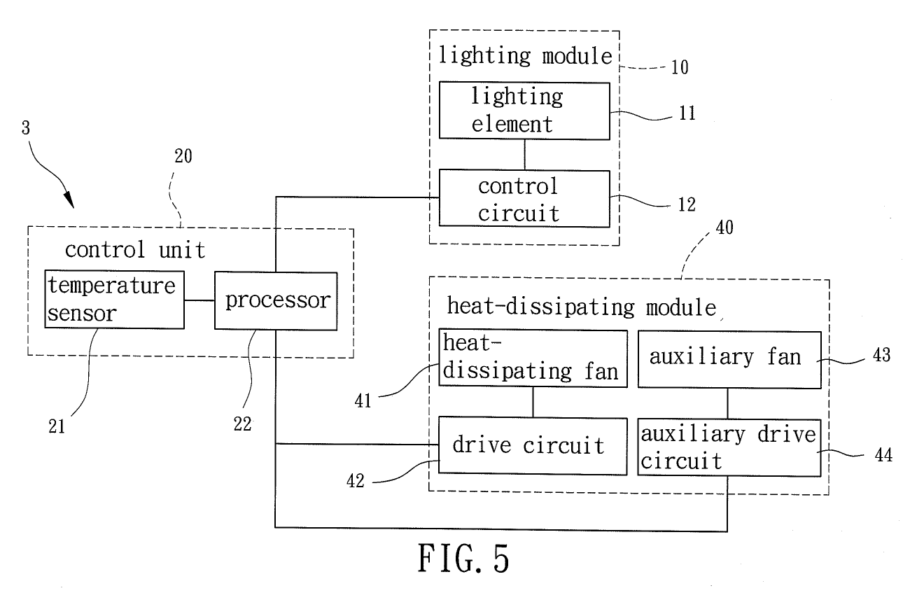

FIG. 5 shows a lamp 3 of a third embodiment according to the preferred teachings of the present invention. In this embodiment, the lamp 3 includes a lighting module 10, a control unit 20, and a heat-dissipating module 40. The lighting module 10 and the control unit 20 are the same as those in the first embodiment and, therefore, not described in detail to avoid redundancy.

The heat-dissipating module 40 of the third embodiment includes a heat-dissipating fan 41, a drive circuit 42, an auxiliary fan 43, and an auxiliary drive circuit 44. The heat-dissipating fan 41 can be directly coupled to the lighting element 11 of the lighting module 10 or located at a side of the lighting element 11. The drive circuit 42 is electrically connected to the heat-dissipating fan 41 and the processor 22 for driving the heat-dissipating fan 41 to rotate. Likewise, the auxiliary fan 43 can be directly coupled to the lighting element 11 of the lighting module 10 or located at a side of the lighting element 11 without adversely affecting the wind-driving effect of the heat-dissipating fan 41. The auxiliary drive circuit 44 is electrically connected to the auxiliary fan 43 and the processor 22 for driving the auxiliary fan 43 to rotate.

As an example of use, during operation of the lamp 3 of the third embodiment, the heat-dissipating module 40 can be utilized to control the temperature of the lighting element 11 in addition to controlling of the brightness of the lighting element 11 by the control unit 20. Specifically, there can only be the heat-dissipating fan 41 to be driven to rotate when the lamp 3 starts operation, and the temperature sensor 21 generates a temperature sensing result after sensing the temperature of the lighting element 11. The processor 22 receives the temperature sensing result and generates a control signal after operation. The control signal is output to the auxiliary drive circuit 44 so that the auxiliary fan 43 can be driven. The heat-dissipating fan 41 and the auxiliary fan 43 together dissipate the high heat generated by the lighting element 11, providing a synergistic heat-dissipating effect. Alternatively, the heat-dissipating fan 41 and the auxiliary fan 43 can be driven to rotate when the lamp 3 starts operation, assuring an excellent heat-dissipating effect for the lighting element 11. When the temperature of the lighting element 11 sensed by the temperature sensor 21 is not so high, a temperature sensing result is generated by the temperature sensor 21 and sent to the processor 22 which generates a control signal after operation. The control signal is output to the auxiliary drive circuit 44 to stop rotation of the auxiliary fan 43. The same heat-dissipating effect can be achieved while saving electricity.

Thus, in addition to avoiding overheating of the lighting element 11 by adjusting the brightness of the lighting element 11 through the control unit 20, the lamp 3 of the third embodiment according to the preferred teachings of the present invention provides a better heat-dissipating effect through operation of the heat-dissipating fan 41 and the auxiliary fan 43. The timing of starting and stopping of the heat-dissipating fan 41 and the auxiliary fan 43 can be adjusted according to the practical operating conditions, providing excellent heat-dissipating function.

Although the control unit 20 of the lamp 1, 2, 3 shown in the first, second, and third embodiments is utilized to control the brightness of the lighting element 11, it can be appreciated that the lamp 1, 2, 3 according to the preferred teachings of the present invention does not have to include the brightness control mechanism. Furthermore, the control unit 20 can be utilized to control operation of the heat-dissipating fan 31, 41 according to the teachings of the present invention for the purposes of avoiding overheating of the lighting element 11.

According to the above, the lamp 1, 2, 3 according to the preferred teachings of the present invention provides a better heat-dissipating effect for the heating element 11 by controlling the brightness of the lighting element 11 and/or by adjusting the operation modes of the heat-dissipating module 30, 40. The lamp 1, 2, 3 according to the preferred teachings of the present invention can operate for a long period of time and has a long service life.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A lamp comprising:
a lighting module including a lighting element and a control circuit electrically connected to the lighting element; and
a control unit including a temperature sensor and a processor electrically connected to the temperature sensor and the control circuit, with the temperature sensor sensing a temperature of the lighting element and generating a temperature sensing result, with the processor controlling brightness of the lighting element based on the temperature sensing result of the temperature sensor.

2. The lamp as claimed in claim 1, further comprising: a heat-dissipating module including a heat-dissipating fan and a drive circuit electrically connected to the heat-dissipating fan, with the processor of the control unit electrically connected to the drive circuit, with the processor controlling an operation mode of the heat-dissipating fan through the drive circuit based on the temperature sensing result of the temperature sensor.

3. The lamp as claimed in claim 2, with the heat-dissipating module further including an auxiliary fan and an auxiliary drive circuit electrically connected to the auxiliary fan and the processor of the control unit, with the processor controlling an operation mode of the auxiliary fan through the auxiliary drive circuit based on the temperature sensing result of the temperature sensor.

4. The lamp as claimed in claim 2, with the heat-dissipating module further including a sink coupled to the lighting element and the heat-dissipating fan.

5. A lamp comprising:
a lighting module including a lighting element and a control circuit electrically connected to the lighting element;
a control unit including a temperature sensor and a processor electrically connected to the temperature sensor; and
a heat-dissipating module including a heat-dissipating fan and a drive circuit electrically connected to the heat-dissipating fan and the processor of the control unit, with the temperature sensor sensing a temperature of the lighting element and generating a temperature sensing result, with the processor controlling an operation mode of the heat-dissipating fan through the drive circuit based on the temperature sensing result of the temperature sensor.

6. The lamp as claimed in claim 5, with the heat-dissipating module further including an auxiliary fan and an auxiliary drive circuit electrically connected to the auxiliary fan and the processor of the control unit, with the processor controlling an operation mode of the auxiliary fan through the auxiliary drive circuit based on the temperature sensing result of the temperature sensor.

7. The lamp as claimed in claim 5, with the heat-dissipating module further including a sink coupled to the lighting element and the heat-dissipating fan.
